(19) United States
(12) Patent Application Publication
(10) Pub. No.: US 2012/0111801 A1
(43) Pub. Date: May 10, 2012

(54) Near-Field Photocatalyst Including Zinc Oxide Nanowire

(75) Inventors: Gyu-chul Yi, Gyungbuk (KR); Motoichi Ohtsu, Tokyo (JP); Takashi Yatsui, Tokyo (JP)

(73) Assignees: Seoul National University R & DB Foundation, Seoul (KR); POSTECH FOUNDATION, Pohang, Kyungbuk-do (KR)

(21) Appl. No.: 12/064,816

(22) PCT Filed: Aug. 31, 2005
(86) PCT No.: PCT/KR05/02882

§ 371 Date: Jul. 28, 2008

(51) Int. Cl. B01J 35/02; B01J 19/12; C02F 1/30; B01J 23/06; C01B 3/00; B82Y 30/00

(52) U.S. Cl. 210/748.09; 502/2; 204/157.52; 204/158.2; 977/902; 977/903

(57) ABSTRACT

Disclosed is a near-field photocatalyst using a ZnO (ZnO) nanowire. The photocatalyst is advantageous in that low-priced zinc is used instead of titanium, conventionally used as a photocatalyst to reduce expenses, and that it is possible to obtain overvoltage which is sufficient to generate hydrogen using an optical near field formed around an end of a ZnO nanowire without the application of additional external voltage, thus the use of a costly electrode, such as platinum, is avoided and a process is simplified.

### TECHNICAL FIELD

The present invention relates, in general, to a photocatalyst and, more particularly, to a near-field photocatalyst using ZnO nanowires.

### BACKGROUND ART

The photocatalyst is a catalytic substance causing a catalytic reaction if light is radiated thereonto. In the present specification, it means a catalytic substance capable of accelerating a photoreaction, and particularly, a substance capable of absorbing ultraviolet rays to produce material having strong oxidizing or reducing power. The photocatalyst may be used to treat a great amount of chemicals or nondegradable contaminants in an environmentally friendly manner. Of the photocatalysts, titanium dioxide is most frequently used because titanium dioxide has excellent acid- or base-resistance and is harmless to humans.

As shown in FIG. 1 a titanium dioxide photocatalyst is an n-type semiconductor, and, if it is exposed to light (for example, ultraviolet light) having energy (λ<400 nm) that corresponds to a band gap of titanium dioxide or higher, electrons on the surface of titanium dioxide are transferred from a valence band to a conduction band, thus holes are formed on the valence band and excess electrons are induced to the conduction band.

The electrons and the holes are diffused into the surface of titanium dioxide, and, the holes react with water or hydroxyl ions (OH⁻) absorbed on the surface of titanium dioxide to generate hydroxyl radicals (OH). Additionally, oxygen existing in water reacts with the electrons to generate super oxide (O₂²⁻). The hydroxyl radical and the super oxide thus generated act as an oxidizing agent which oxidizes organic substances and thus converts them into water and carbonic acid gas. Furthermore, since bacteria are organic compounds, they are oxidized and thus decomposed by a strong oxidation function of the photocatalyst, thereby sterilization is achieved. The above-mentioned function of titanium dioxide is disclosed in Korean Patent Laid-Open Publication No. 10-2003-0083901.

However, titanium is very rare metal and titanium dioxide is very costly material, thus there are serious problems in the commercialization of titanium dioxide.

In addition to the above-mentioned function, titanium dioxide is used as an electrode for a photochemical cell as is strontium titanate (SrTO₃). That is to say, titanium dioxide is a semiconductor photocatalyst which generates a photoelectromotive force if it receives light, such as sunbeams, and which causes an electrochemical reaction due to the photoelectromotive force. It may be used to electrolyze water by radiating light onto a titanium dioxide electrode after a platinum electrode and a titanium oxide electrode are provided in water, so as to generate hydrogen. The function and use of titanium dioxide are disclosed in Korean Patent Registration No. 10-0377825.

However, if the titanium dioxide photocatalyst is used to electrolyze water employing sunbeams, it is necessary to assure a photoelectromotive force that is identical to or higher than a minimum electromotive force (theoritical value: 1.23 V) required to electrolyze water. Accordingly, an additional external voltage is applied thereto, which undesirably makes a device and a process for generating hydrogen very complicated. Furthermore, since rare metal, such as platinum, is used for an electrode, undesirably, the production cost increases.

Meanwhile, near field light has been used in a high resolution optical microscope, a high density optical memory, and atom manipulation [Near-Field Nano/Atom Optics and Technology, Springer, Tokyo, 1998].

### DISCLOSURE OF INVENTION

### Technical Problem

Accordingly, the present invention has been made keeping in mind the above problems occurring in the prior art, and an object of the present invention is to provide a photocatalyst including ZnO instead of titanium. Unlike titanium, zinc is low-priced metal which is readily purchased in a great amount at low cost, thus the production cost of the photocatalyst is significantly reduced.

Another object of the present invention is to provide a photocatalyst in which ZnO constitutes a nanowire. Due to near fields generated around ends of nanowires, it is possible to obtain an electric potential required to generate hydrogen without the use of additional electrodes or the application of additional voltage.

### Technical Solution

In order to accomplish the above objects, the present invention provides a near-field photocatalyst. The near-field photocatalyst comprises a substrate, and a base including nanomaterial a base formed on the substrate and including nanomaterial which includes one or more selected from ZnO, TiO₂, GaP, ZrO₂, SiCdS, KTaO₂, KTaNBO, CdSe, SrTiO₃, Nb₂O₃, Fe₂O₃, WO₂, SaO₂ or mixture thereof as a main component and which has a shape of a nanowire including a nanoneedle, a nanorod, or a nanotube.

Especially, the nanomaterial is preferred to include ZnO as a main component.

The nanomaterial preferably has the shape of a nanoneedle, and also has a diameter of less than 200 nm, more preferably 5-200 nm, and a length of 0.5-100□.

The substrate is selected from the group consisting of a silicon substrate, a glass substrate, a quartz substrate, a Pyrex substrate, a sapphire substrate, and a plastic substrate.

The nanomaterial is oriented on the substrate to be perpendicular in accordance with the substrate form.

The nanomaterial is formed on the substrate through any one of a metal-organic vapor phase epitaxy process, a metal-organic chemical vapor deposition process, a sputtering process, a thermal or electron beam evaporation process, a pulse laser deposition process, a vapor-phase transport process, and a chemical synthesis process.

The nanomaterial comprises one or more elements selected from a group consisting of Mg, Cd, Ti, Li, Cu, Al, Ni, Y, Ag, Mn, V, Fe, La, Ta, Nb, Ga, In, S, Se, P, As, Co, Cr, B, N, Sb, and H, as impurities, in addition to ZnO as the main component.

The oxide-based nanomaterial is coated with any one compound selected from a group consisting of MgO, CdO, GaN, MN, InN, GaAs, GaP, InP, and compounds thereof.

Meanwhile, the present invention provides a method of generating hydrogen using the photocatalyst according to the present invention, and a device for generating hydrogen, which comprises the photocatalyst according to the present invention.

Furthermore, the present invention provides a method of purifying wastewater or air using the photocatalyst according to the present invention, and a device for purifying wastewater or air, which comprises the photocatalyst according to the present invention.

### Advantageous Effects

The photocatalyst of the present invention is advantageous in that low-priced zinc is used instead of titanium, conventionally used as a photocatalyst to reduce expenses, and that it is possible to obtain overvoltage which is sufficient to generate hydrogen using an optical near field formed around an end of a ZnO nanowire without the application of additional external voltage, thus the use of a costly electrode, such as platinum, is avoided and a process is simplified.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a reaction mechanism of a photocatalyst;

FIG. 2 illustrates a band structure of a representative photocatalyst material, and oxidation and reduction levels of water;

FIG. 3 illustrates excitation of a molecular vibration mode by near field light;

FIGS. 4 and 5 are a view illustrating a ZnO nanoneedle photocatalyst in which a nanoneedle is coated with GaN according to the present invention, and a transmission electron microscope (TEM) picture thereof, respectively;

FIG. 6 is a scanning electron microscope (SEM) picture of the ZnO nanoneedle photocatalyst produced according to the present invention;

FIG. 7 is a TEM picture of the ZnO nanoneedle photocatalyst produced according to the present invention;

FIG. 8 illustrates SEM pictures of surfaces of nanoneedles after light is radiated onto the ZnO nanoneedle photocatalyst according to the present invention; and

FIG. 9 is a graph illustrating the EDX analysis result of the ZnO nanoneedle photocatalyst according to the present invention.

### BEST MODE FOR CARRYING OUT THE INVENTION

Hereinafter, a detailed description will be given of the present invention. In the description of the present invention, if it is considered that a detailed description of related prior arts or constitutions may unnecessarily obscure the gist of the present invention, such detailed description will be omitted. Furthermore, the terminology as described later is defined in consideration of functions of the present invention, and depends on the purpose of a user or a worker, or a precedent. Therefore, the definition must be understood in the context of the specification.

A near-field photocatalyst of the present invention is characterized in that it includes nanomaterial consisting mostly of ZnO instead of costly titanium dioxide which is conventionally frequently employed. As shown in FIG. 2, ZnO has an energy band gap and a catalytic activity level for generation of hydrogen that are almost the same as those of titanium dioxide, thus being used as material for generating hydrogen at the same level as titanium dioxide. Particularly, it can be used to electrolyze water.

Furthermore, the present invention relates to a near-field photocatalyst in which nanomaterial including ZnO as a main component forms a nanowire, such as a nanorod, a nanotube, or preferably a nanoneedle, on a substrate.

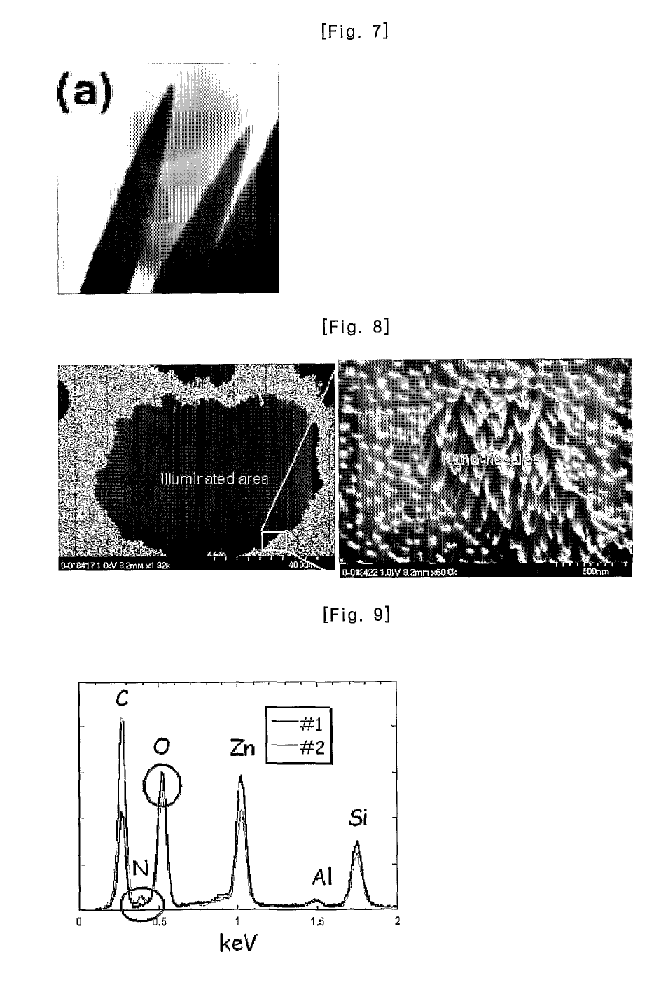

Particularly, in the case of the ZnO nanomaterial comprising the nanoneedle-shaped nanowire, as shown in FIGS. 6 and 7, it is possible to produce it so that one end is made very sharp by controlling growth conditions.

Particularly, it is preferable that the ZnO nanomaterial have a diameter of less than 200 nm, more preferably 5-200 nm, and a length of 0.5-100□.

Intensity of far field light is uniform throughout a neutral molecule in which the intensity is smaller than a wavelength thereof. In this case, only electrons in the molecule respond to an electric field having a phase and intensity that are identical thereto. Accordingly, in a far field, it is impossible to increase the energy of molecular vibration.

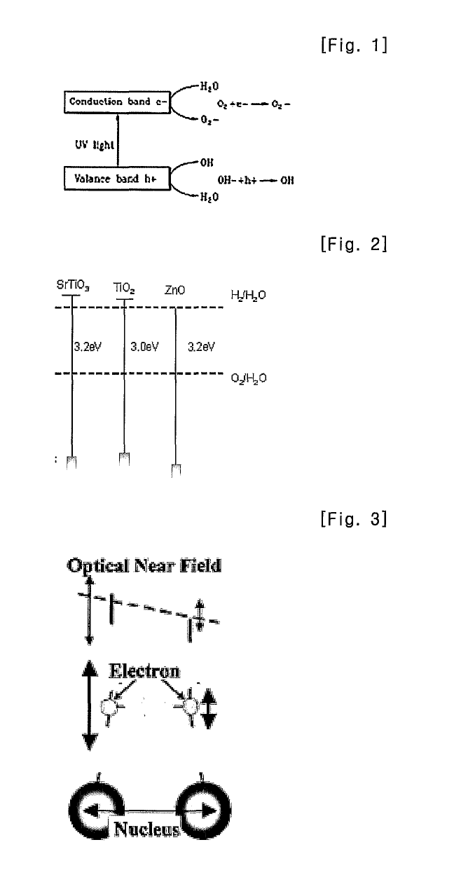

On the other hand, as for near field light, intensity of the field is nonuniform throughout a molecule due to a steep spatial gradient depending on a position thereof. In this case, as shown in FIG. 3, a molecular orbit changes to cause nonuniform response of electrons. Due to the nonuniform response of the electrons, the molecule is polarized.

If far field light is radiated onto the photocatalyst having the above-mentioned structure according to the present invention, an optical near field is formed around ends thereof. In the optical near field which is formed around the ends, since a gradient of the electric field is very steep, it is possible to assure overvoltage sufficient to generate hydrogen without the addition of additional external voltage.

As described above, when the titanium dioxide photocatalyst is used to electrolyze water, it is necessary to apply the external voltage thereto using rare metal, such as platinum, as the electrode in order to assure a photoelectromotive force that is identical to or higher than a minimum electromotive force (theoritical value: 1.23 V) required to electrolyze water. In connection with this, the present invention is advantageous in that it is possible to obtain the overvoltage required to generate hydrogen without use of a costly electrode, such as platinum, or the application of additional external voltage, thus it is possible to significantly simplify a device and a process for generating hydrogen and to reduce a production cost.

Furthermore, if the ZnO nanoneedle is used as a material of the photocatalyst, reaction efficiency within a visible region is improved, thus total energy conversion efficiency is significantly increased.

In the photocatalyst of the present invention, a substrate is material which does not usually react with the oxide-based nanomaterial to be formed thereon, and non-limiting examples include a silicon substrate, a glass substrate, a quartz substrate, a Pyrex substrate, a sapphire substrate, or a plastic substrate.

Meanwhile, preferably, the ZnO nanomaterial of the present invention is oriented on the structure to be perpendicular in accordance with the substrate form, but, in the photocatalyst of the present invention, the nanomaterial may be otherwise oriented on the substrate.

Additionally, it is possible to force electrons generated by light to gather toward metal using the above-mentioned metal/oxide semiconductor heterostructure, thus it is possible to reduce a recombination speed between the electrons and the holes. Accordingly, the electrons and the holes are easily combined with external oxygen or water, resulting in improved photolysis efficiency of external contaminants.

The nanomaterial of the present invention is formed on various substrates through a physical growth process, such as a metal-organic vapor phase epitaxy (MOVPE) process, a chemical vapor deposition process including a metal-organic vapor deposition process, a sputtering process, a thermal or electron beam evaporation process, and a pulse laser deposition process, a vapor-phase transport process using a metal catalyst, such as gold, or a chemical synthesis process. Preferably, the growth may be conducted through the metal-organic vapor phase epitaxy (MOVPE) process or the metal-organic chemical vapor deposition (MOCVD) process.

In the method of producing the photocatalyst of the present invention, ZnO nanoneedles are formed on the substrate through the following procedure. Firstly, zinc-containing organometal and oxygen-containing gas or oxygen-containing organics are fed through separate lines into an organometallic vapor deposition reactor. Non-limiting examples of the zinc-containing organometal include dimethylzinc [Zn(CH₃)₂], diethylzinc [Zn(C₂H₅)₂], zinc acetate [Zn(OOCCH₃)₂H₂O], zinc acetate anhydride [Zn(OOCCH3)2], or zinc acetyl acetonate [Zn(C₅H₇O₂)₂], and non-limiting examples of the oxygen-containing gas include O₂, O₃, NO₂, steam, or CO₂. Non-limiting examples of the oxygen-containing organics include C₄H₈O.

Subsequently, the above reactants react at a pressure of 10⁻⁵-760 mmHg and a temperature of 200-900° C. to deposit and grow ZnO nanoneedles on the substrate. The reaction pressure, temperature and flow rates of the reactants are controlled to adjust the diameter, length, and density of each nanoneedle to be formed on the substrate, thereby it is possible to form nanomaterial having a desired total surface area on the substrate.

To improve electron and hole forming ability of the ZnO nanomaterial of the photocatalyst according to the present invention, the ZnO nanomaterial may further comprise one or more elements, which are selected from the group consisting of Mg, Cd, Ti, Li, Cu, Al, Ni, Y, Ag, Mn, V, Fe, La, Ta, Nb, Ga, In, S, Se, P, As, Co, Cr, B, N, Sb, and H, as impurities. In this case, if the concentration of the impurity is high, the nanomaterial may be called an alloy of the oxide semiconductor material. The nanomaterial of the present invention may contain the above element by feeding organometal containing the above element in conjunction with zinc-containing organometal into the organometallic vapor deposition reactor.

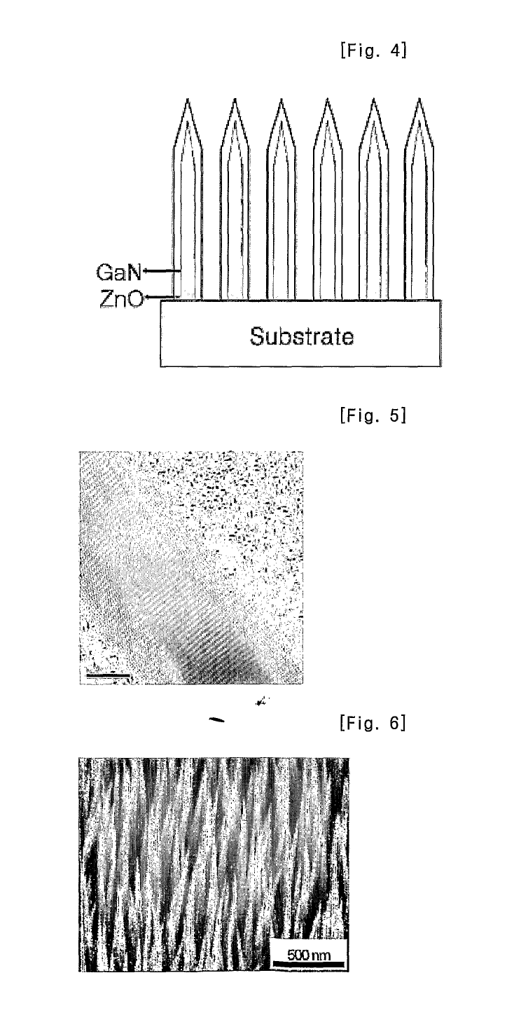

Meanwhile, the nanomaterial of the photocatalyst according to the present invention may be coated with a compound selected from the group consisting of MgO, CdO, GaN, AlN, InN, GaAs, GaP, InP, or a compound thereof. FIG. 4 illustrates oxide-based nanoneedles which are perpendicularly oriented on a substrate and which are coated with GaN, and FIG. 5 shows a transmission electron microscope picture of the nanoneedles having the above structure. The coating layer of the material improves the electron and hole forming ability and forms a protective layer made of nanomaterial, thereby variously affecting the photocatalyst of the present invention.

### MODE FOR THE INVENTION

A better understanding of the present invention may be obtained through the following examples which are set forth to illustrate, but are not to be construed as the limit of the present invention.

### Example 1

### Production of Photocatalyst Including ZnO Nanoneedle (MOCVD)

A glass substrate was put in a metal-organic chemical vapor deposition (MOCVD) reactor, and dimethylzinc (Zn(CH₃)₂) and O₂ gas were fed through separate lines into the reactor at rates of 0.1-10 sccm and 10-100 sccm, respectively. In connection with this, argon (Ar) was used as carrier gas.

Dimethylzinc and oxygen were chemically reacted on the glass substrate while an inside of the reactor was maintained at a pressure of 0.2 torr and a temperature of 500° C. for 1 hour to grow and deposit the ZnO nanoneedles thereon.

The ZnO nanoneedles which were oriented on the resulting glass substrate to be perpendicular in accordance with the substrate form are shown in FIG. 6, and each of them had a diameter of 60 nm, a length of 1□, and a density of 1010/cm².

### Example 2

### Production of Photocatalyst Including ZnO Nanoneedle (MOVPE)

After a substrate was put in a reactor, dimethylzinc (Zn(CH₃)₂) and O₂ as sources of gas were fed through separate lines into the reactor at rates of 0.1-10 sccm and 10-100 sccm, respectively, while a temperature of the substrate was maintained at 400-500° C. In connection with this, argon (Ar) was used as carrier gas.

Dimethylzinc and oxygen were chemically reacted on the glass substrate while an inside of the reactor was maintained at a pressure of 0.2 torr and a temperature of 500° C. for 1 hour to grow and deposit the ZnO nanoneedles thereon. As shown in FIG. 7, the nanoneedles with sharp ends were formed on the substrate to be perpendicular in accordance with the substrate form.

### Evaluation Example 1

The ZnO nanoneedle photocatalysts produced in examples 1 and 2 were immersed in ultra pure distilled water and then exposed to a He—Cd laser having a wavelength of 325 nm for 30 sec. As a result, ultra hydrophilicity was obtained, like that of titanium dioxide.

Furthermore, precipitation of material around the exposed portion in water was confirmed by observing surfaces using an electron microscope, which is shown in FIG. 8. Additionally, from the fact that the precipitation was formed so as to bridge ends of the nanoneedles, it can be seen that the material was precipitated due to an optical near field formed around the ends of the nanoneedles.

### Evaluation Example 2

The material which was attached to the surface so as to bridge the ends of the photocatalysts of the present invention was subjected to a composition analysis, and the results are shown in FIG. 9. In FIG. 9, #1 corresponds to a light radiation region, and #2 corresponds to a non-radiation region. From FIG. 9, it can be seen that amounts of carbon and nitrogen components increased on the light radiation region, which means that organic impurities and nitrogen were precipitated from water. From this, it was confirmed that quality of water was improved using the ZnO nanoneedles.

### INDUSTRIAL APPLICABILITY

Recently, a photocatalyst technology has been commercialized in extensive fields and watched all over the world. A near-field photocatalyst technology using a ZnO nanowire according to the present invention is very important in view of commercialization in that it provides material capable of being used instead of costly titanium oxide, and the present invention which does not require an electrode significantly contributes to process simplification.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A near-field photocatalyst using an optical near field formed around an end of a nanowire, comprising:
a substrate; and
a base formed on the substrate and including nanomaterial which includes one or more selected from ZnO, TiO2, GaP, ZrO2, Si CdS, KTaO2, KTaNBO, CdSe, SrTiO3, Nb2O3, Fe2O3, WO2, SaO2 or mixture thereof as a main component and which has a shape of a nanowire including a nanoneedle, a nanorod, or a nanotube.

2. The near-field photocatalyst as set forth in claim 1, wherein the nanomaterial has the shape of a nanoneedle.

3. The near-field photocatalyst as set forth in claim 2, wherein the ZnO nanomaterial has a diameter of less than 200 nm, and a length of 0.5-100 μm

4. The near-field photocatalyst as set forth in claim 1, wherein the substrate is selected from a group consisting of a silicon substrate, a glass substrate, a quartz substrate, a Pyrex substrate, a sapphire substrate, and a plastic substrate.

5. The near-field photocatalyst as set forth in claim 1, wherein the ZnO nanomaterial is oriented on the substrate to be perpendicular in accordance with the substrate form.

6. The near-field photocatalyst as set forth in claim 1, wherein the ZnO nanomaterial is formed on the substrate through any one of a metal-organic vapor phase epitaxy process, a metal-organic chemical vapor deposition process, a sputtering process, a thermal or electron beam evaporation process, a pulse laser deposition process, a vapor-phase transport process, and a chemical synthesis process.

7. The near-field photocatalyst as set forth in claim 1, wherein the ZnO nanomaterial comprises one or more elements selected from a group consisting of Mg, Cd, Ti, Li, Cu, Al, Ni, Y, Ag, Mn, V, Fe, La, Ta, Nb, Ga, In, S, Se, P, As, Co, Cr, B, N, Sb, and H, as impurities, in addition to ZnO as the main component.

8. The near-field photocatalyst as set forth in claim 1, wherein the oxide-based nanomaterial is coated with any one compound selected from a group consisting of MgO, CdO, GaN, AlN, InN, GaAs, GaP, InP, and compounds thereof.

9. A method of generating hydrogen using a photocatalyst, the photocatalyst comprising:
a substrate; and
a base including nanomaterial which has a shape of a nanowire including a nanoneedle, a nanorod, or a nanotube on the substrate and which has ZnO as a main component.

10. The method as set forth in claim 9, wherein the nanomaterial has the shape of a nanoneedle.

11. The method as set forth in claim 10, wherein the ZnO nanomaterial has a diameter of less than 200 nm and a length of 0.5-100 μm

12. A device for generating hydrogen, comprising:
a photocatalyst comprising:
a substrate; and
a base including nanomaterial which has a shape of a nanowire including a nanoneedle, a nanorod, or a nanotube on the substrate and which has ZnO as a main component.

13. The device as set forth in claim 12, wherein the nanomaterial has the shape of a nanoneedle.

14. The device as set forth in claim 13, wherein the ZnO nanomaterial has a diameter of less than 200 nm and a length of 0.5-100 μm

15. A method of purifying wastewater or air using a photocatalyst, the photocatalyst comprising:
a substrate; and
a base including nanomaterial which has a shape of a nanowire including a nanoneedle, a nanorod, or a nanotube on the substrate and which has ZnO as a main component.

16. The method as set forth in claim 15, wherein the nanomaterial has the shape of a nanoneedle.

17. The method as set forth in claim 16, wherein the ZnO nanomaterial has a diameter of less than 200 nm and a length of 0.5-100 μm

18. A device for purifying wastewater or air, comprising:
a photocatalyst comprising:
a substrate; and
a base including nanomaterial which has a shape of a nanowire including a nanoneedle, a nanorod, or a nanotube on the substrate and which has ZnO as a main component.

19. The device as set forth in claim 18, wherein the nanomaterial has the shape of a nanoneedle.

20. The device as set forth in claim 19, wherein the ZnO nanomaterial has a diameter of less than 200 nm and a length of 0.5-100 μm
